(19) United States
(12) Patent Application Publication
(10) Pub. No.: US 2004/0068658 A1
(43) Pub. Date: Apr. 8, 2004

(54) Electronic commerce method

(75) Inventors: Takeshi Arisaka, Kawasaki (JP); Kaori Kondo, Yamato (JP); Nobuo Beniyama, Kawasaki (JP); Hiroshi Koike, Maebashi (JP); Mitsuteru Omata, Zama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/620,567

(22) Filed: Jul. 15, 2003

(30) Foreign Application Priority Data
Oct. 8, 2002 (JP) 2002-294375

(51) Int. Cl. H04L 9/00

(52) U.S. Cl. 713/176; 705/75

(57) ABSTRACT

In electronic commerce, common template data is stored in two processors in advance. A data sending processor encrypts original information, generates difference information, and packages the encrypted original information and the difference information. A data receiving processor un-packages received data, restores the original information from the difference information and the template data, decrypts encrypted data, and checks whether the decrypted data matches the restored original information.

### BACKGROUND OF THE INVENTION

The present invention relates to an electronic commerce method using electronic documents and more particularly to an electronic commerce method suitable for carrying out business activities while communicating electronic documents among persons in charge who are distributed in a network environment.

In electronic commerce where a purchaser sends a purchase order form to a vendor as an electronic document and the vendor conducts a business activity according to the received purchase order form, it has been desired that the vendor or a third party be able to presume that the purchase order form has been filled out by the purchaser and that there is no substitution or impersonation. This problem has been solved by the so-called Digital Signature Act. Under this Act, a purchaser attaches a digital signature to a purchase order form using digital signature technology to which encryption technology, such as public key encryption, is applied (for example, U.S. Patent Application Publication US2002/0040431A1).

On the other hand, in electric commerce using technology such Web-EDI, a difference from the original is sent to reduce the amount of data transmission, and the vendor conducts a business activity using purchase information obtained from the original and the difference. In this transaction, it is supposed that the purchaser and the vendor agree in advance that the vendor side system, which receives difference information, generates purchase information from the original and the difference. To support this agreement, the sending side system and the receiving side system strictly manage the encryption of data sent or received over a communication line and data that has been sent and received. When digital signature technology is used for electronic commerce in which such difference information is transferred, the difference information is supposed to be sent potentially with a digital signature attached. Digital signature technology allows a vendor or a third party to presume that the difference information is composed of data created by a purchaser.

However, if the original is substituted or if the order receiving information obtained from the original and the different is substituted, a business activity is conducted according to the information not intended by the purchaser, potentially resulting in some disadvantages. In this case, it can only be presumed by the Digital Signature Act that the difference information was created by the purchaser; information substitution is beyond the scope of the Digital Signature Act. For example, a malicious vendor substitutes Kg (Kilogram) for g (gram) as the unit of a purchase item included in the original, the purchase information created from the original and the difference is the one not intended by the purchaser and therefore the purchaser suffer disadvantages. In this case, who substituted the original or whether the electronic commerce system is faulty is controversial.

### SUMMARY OF THE INVENTION

As described above, when a digital signature is attached simply to difference information as in the conventional digital signature technology, the receiver can only presume that the difference information was created by the sender but cannot verify the signature attached to the electronic document.

For use in electronic commerce in which difference information of the original is transferred, it is an object of the present invention to provide an electronic commerce method that allows a receiver or a third party to presume that information obtained from the original and the difference information was created by the sender.

To reduce a data transfer amount by sending difference information while preventing electronic document substitution or impersonation, common template data is pre-stored in two processors. When electronic commerce is conducted, difference information is generated by removing template data from the original information. The data sending processor encrypts the original information, generates difference information, packages the encrypted original information and the difference information, and sends them. The data receiving processor un-packages the received packaged data, restores the original information from the difference information and the template data, decrypts the encrypted data, and checks if the decrypted data matches the restored original information.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the hardware configuration.

FIG. 2 is a diagram showing the software configuration.

FIG. 3 is a diagram showing the structure of a private key file and a public key file.

FIG. 4 is a flowchart showing the procedures for creating keys.

FIG. 5 is a flowchart showing the processing of an order data creation program.

FIG. 6 is a diagram showing a layout information storage database.

FIG. 7 is a diagram showing an example of purchase order forms that are filled out.

FIG. 8 is a diagram showing a job history database and an electronic document data accumulation database in a processor 1.

FIG. 9 is a flowchart showing purchase order form correction and re-issuance processing.

FIG. 10 is a flowchart showing the processing of a transmission data generation control program.

FIG. 11 is a flowchart showing processing executed by a processor 2 after receiving a purchase order form.

FIG. 12 is a diagram showing an electronic document data accumulation database in the processor 2.

FIG. 13 is a diagram showing the outline of processing of the present invention.

### DESCRIPTION OF THE EMBODIMENTS

Some embodiments of the present invention will be described with reference to the drawings.

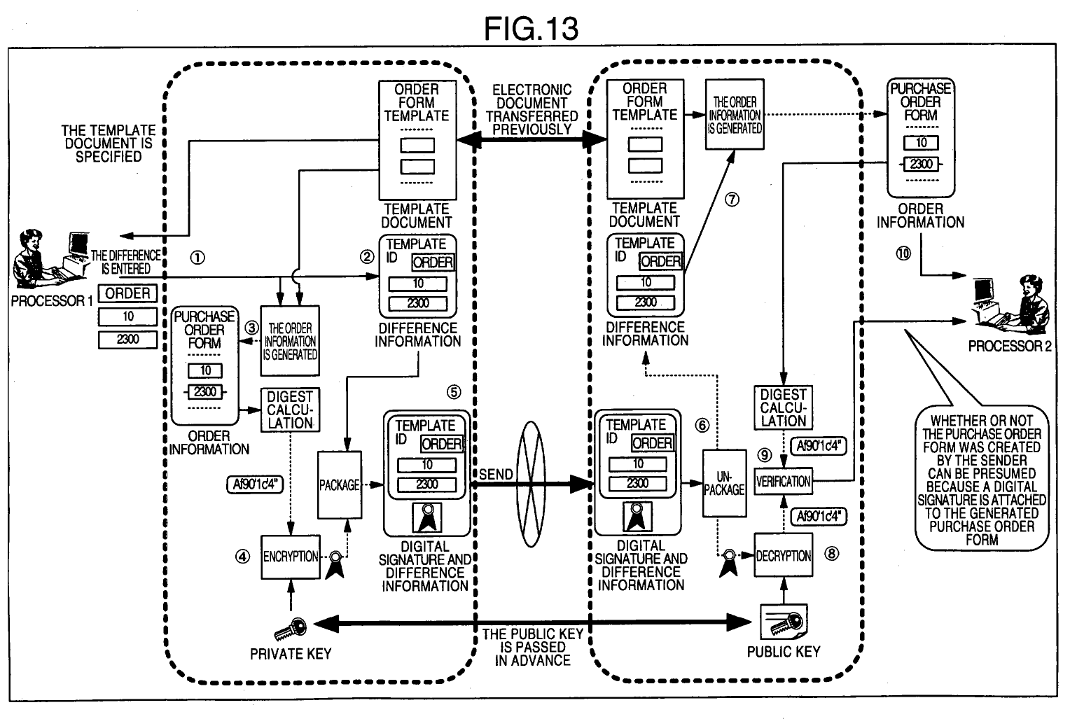

The contents of a job in this embodiment will be described with reference to FIG. 13. In accordance with the present invention, a plurality of clerks are doing jobs, such as electronic document data entry, in an environment in which two or more (two in this example) processors 1 and 2 are connected via a wired or wireless network. In this example, order issuing and order receiving jobs are processed as follows. An order-sending clerk on the processor 1 fills out a purchase order form, encrypts it, and then sends it to an order-receiving clerk so that the order-receiving clerk who will receive the purchase order form can confirm that the purchase order form was filled out by the order-sending clerk.

The order-receiving clerk on the processor 2 receives the purchase order form over a network (the Internet in this example), decrypts the data, and confirms that there is no data inconsistency between the processor 1 and the processor 2 or there is no substitution in the transferred data, that is, confirms that the purchase order form was filled out surely by the order-sending clerk. Then, the order-receiving clerk does an order-receiving job based on the purchase order form.

The processors 1 and 2 store therein a common template document in advance. The public key corresponding to the private key is stored on the hard disk of the processor 2.

(1) On the processor 1, the order-sending clerk enters the difference part of the purchase order form (for example, the type number, and the number of items, of the product to be ordered) and the template ID identifying the template document.

(2) Difference information, which is in the form of a binary data string, is generated from the difference and the template ID obtained in (1).

(3) The template document is identified by the template ID entered in (1), and this template document is merged with the difference to generate order information.

(4) The digest of the order information created in (3) is calculated, and this digest is encrypted with the private key of the order-sending clerk to generate a digital signature.

(5) The difference information generated in (2) and the digital signature for the order information generated in (4) are packaged, and the packaged information is sent to the processor 2.

(6) On the processor 2, the information sent in (5) is unpackaged into the difference information and the digital signature.

(7) The difference and the template ID are extracted from the difference information obtained in (6), the template document is identified by the template ID, and the template document is merged with the difference to generate the order information.

(8) The digital signature obtained in (6) is decrypted with the public key of the order-sending clerk.

(9) The digest of the order information generated in (7) is calculated, and a check is made if it matches the value obtained in (8) to verify the signature.

(10) On the processor 2, the verified order information is output to the order-receiving clerk.

In the electronic commerce method according to the present invention, the digital signature of the order-sending clerk is attached to the order information and, in step (8), the processor 2 can presume that the order information was created by the order-sending clerk. Outputting a pair of the digital signature obtained in (6) and the order information generated in (7) allows the order-receiving clerk or a third party to presume that the order information was created by the order-sending clerk using the public key of the order-sending clerk.

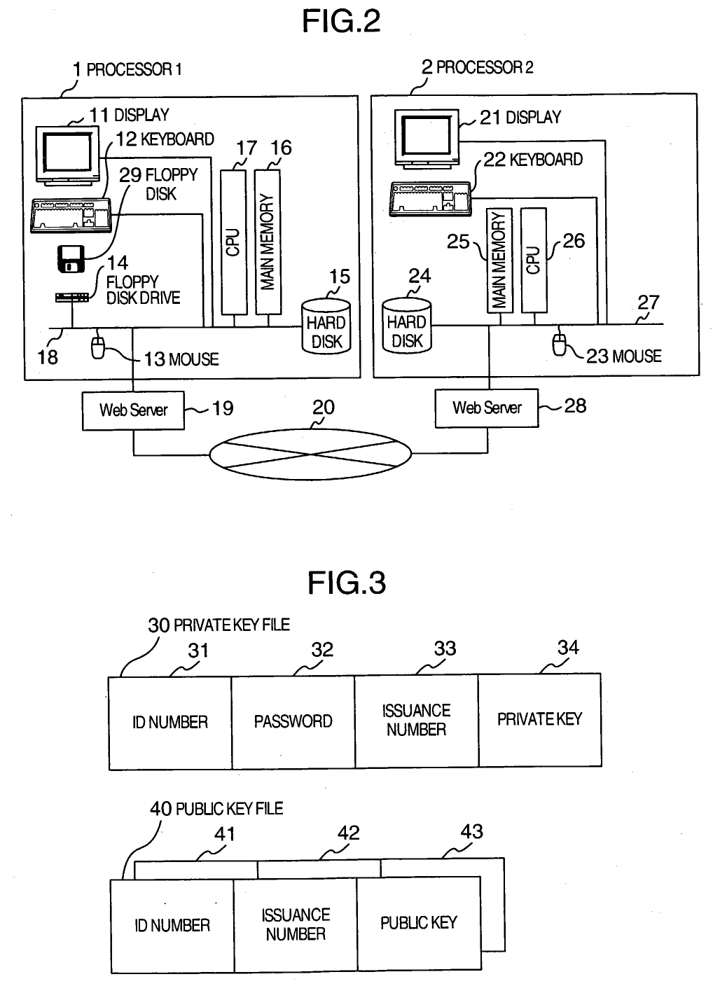

With reference to FIG. 2, the hardware configuration of this embodiment will be described.

The processor 1 has hardware necessary for sending an electronic document. The hardware includes a display 11, a keyboard 12, a mouse 13, a floppy disk drive 14, a floppy disk 29, a hard disk 15, a main memory 16, and a CPU 17. The display 11, keyboard 12, mouse 13, floppy disk drive 14, hard disk 15, and main memory 16 are accessed by the CPU 17 via a bus 18. The floppy disk 29 can be accessed via the floppy disk drive 14. The processor 1 is connected to the Internet 20 via a server 19.

The processor 2 has hardware necessary for receiving an order. The hardware includes a display 21, a keyboard 22, a mouse 23, a hard disk 24, a main memory 25, and a CPU 26. The display 21, keyboard 22, mouse 23, hard disk 24, and main memory 25 are accessed by the CPU 26 via a bus 27. The processor 2 is connected to the Internet 20 via a server 28.

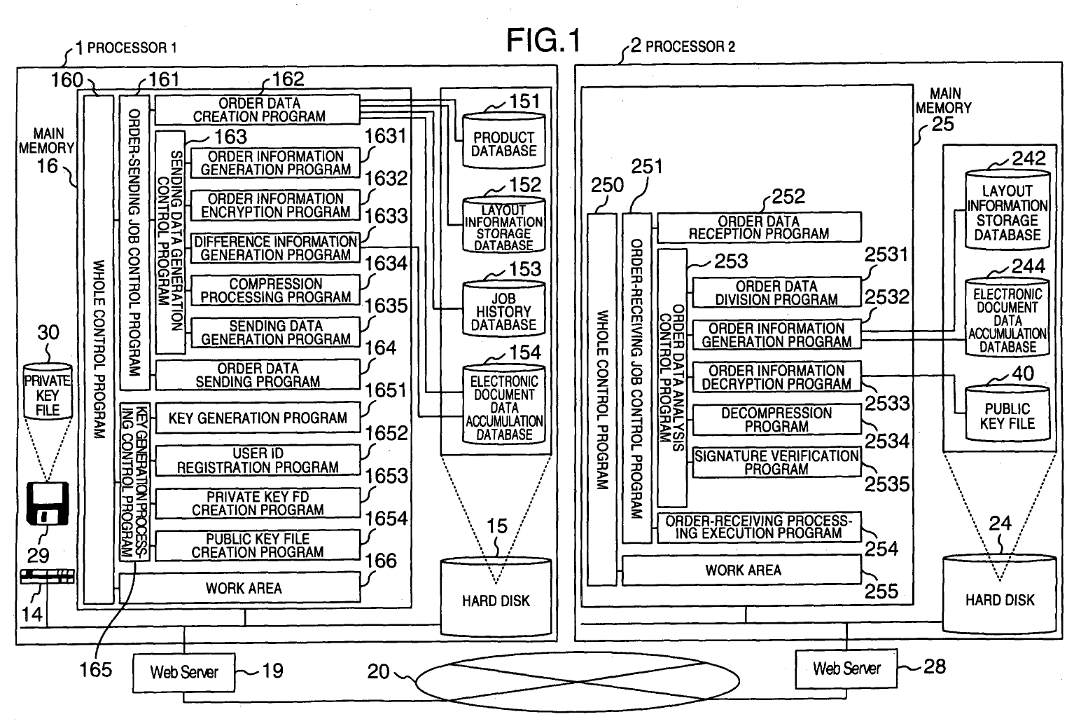

The software configuration of this embodiment will be described with reference to FIG. 1. A whole control program 160, which controls the processor 1, is always loaded in the main memory 16 of the processor 1. When an order-sending job is executed, an order-sending job control program 161, an order data creation program 162, a sending data generation control program 163, and an order data sending program 164 are also loaded into the memory 16. The sending data generation control program 163 is composed of an order information generation program 1631, an order information encryption program 1632, a difference information generation program 1633, a compression processing program 1634, and a sending data generation program 1635.

In this embodiment, a private key and a public key required for encryption must be prepared before executing an order job. A private key and a public key may be created (issued) by a third party such as a certificate authority, which however requires a charge to be paid to the certificate authority. Therefore, in this embodiment, the processor 1 creates a private key and a public key. In the main memory 16 of the processor 1, a key generation processing control program 165, a key generation program 1651, a user ID registration program 1652, a private key FD creation program 1653, and a public key file creation program 1654 are temporarily loaded as a key generation system. A work area 166 is always reserved. The hard disk 15 stores a product database 151, a layout information storage database 152, a job history database 153, and an electronic document data accumulation database 154. A private key (encryption key) file 30, which is stored in the floppy disk 29, is referenced via the floppy disk drive 14.

A whole control program 250, which controls the processor 2, is always loaded in the main memory 25 of the processor 2. When an order-receiving job is executed, an order-receiving job control program 251, an order data reception program 252, an order data analysis control program 253, and an order-receiving processing execution program 254 are loaded in the main memory 25. The order data analysis control program 253 is composed of an order data division program 2531, an order information generation program 2532, an order information decryption program 2533, a decompression program 2534, and a signature verification program 2535. A work area 255 is always reserved. The hard disk 24 stores a public key file 40, a layout information storage database 242, and an electronic document data accumulation database 244.

Order-sending processing is executed in the hardware and software configuration described above. The contents of the layout information storage database 152 stored on the hard disk 15 of the processor 1 are the same as those of the layout information storage database 242 stored on the hard disk 24 of the processor 2. The public key file 40 corresponding to the private key file 30 used by the processor 1 is stored on the hard disk 24 of the processor 2.

On the processor 1, the order-sending job control program 161 starts the order data creation program 162 to allow a clerk to enter data, necessary for issuing a purchase order form ((1) in FIG. 13), and generates order information ((3) in FIG. 13). To check whether or not data is substituted on the network, order information or a part of order information and encrypted order information are packaged for transmission. On the receiving side, the received data is unpackaged and then the order information or a part of the order information is compared with the decrypted order information. After creating order information, the sending data generation control program 163 is started to control a sequence of processing in which order information or a part of order information and encrypted order information are packaged.

Encrypting data increases the amount of data, which, in turn, increases the communication load. To prevent this, the message digest of data to be encrypted is created and the created message digest is encrypted. The message digest is a predetermined range of integer values generated from a character string using a special function called a hash function. A hash function is a one-way function, and SHA-1, MD5, and so on are available. The original data cannot be restored from a message digest. Even if one unit of input data and another unit of input data differ only in one bit, a hash function generates two different digests whose values differ greatly. This means that the digest of the original file, if saved, may be used to check if the file has been changed. The encryption of a message digest is characterized in that the encrypted message digest requires a data amount smaller than that of the original file and in that a substitution, if present, can be detected easily.

To encrypt a message digest, the order information generation program 1631 is used to get the message digest of the order information created by the order data creation program 162 ((4) in FIG. 13). The order information encryption program 1632 uses the private key file 30 to encrypt the order information ((4) in FIG. 13). To package only a part of the order information, the difference information generation program 1633 is used to extract only information, necessary for order-sending job processing, as the difference information ((2) in FIG. 13) and, if necessary, the compression processing program 1634 is used to compress the order information or a part of the order information. The sending data generation program 1635 packages the order information or the difference information and the encrypted data, and the order data sending program 164 sends the packaged result to the processor 2 where order job processing is executed ((5) in FIG. 13).

On the processor 2, order-receiving processing is executed. The order-receiving job control program 251 always keeps the order data reception program 252 running and, upon receiving data, starts the order data analysis control program 253. The order data division program 2531 divides the received data into the order information or the difference information and the encrypted data ((6) in FIG. 13), the order information generation program 2532 generates the order information based on the difference information if the information is the difference information ((7) in FIG. 13), and the order information decryption program 2533 decrypts the encrypted data using the public key ((8) in FIG. 13). The decompression program 2534 decompresses the data if it is compressed, and the signature verification program 2535 compares the decrypted data with the order information. If the decrypted data is a message digest, the message digest of the order information is calculated and is compared with the decrypted message digest. If they match, it is determined that the order information was created surely by the order-sending clerk ((9) in FIG. 13). Then, it becomes possible to do the reception job for the received order information. The order-receiving clerk starts the order-receiving processing execution program 254 ((10) in FIG. 13).

The following describes the encryption and decryption of data used in this embodiment. To encrypt and decrypt data, the public key encryption algorithm (for example, RSA, DSA, ECDSA) is used in which a key used for encryption is different from a key used for decryption. This algorithm uses a pair of keys, private key and public key, and data encrypted with a private key can be decrypted only with the corresponding public key. FIG. 3 shows the contents of the private key file 30 and the public key file 40. The private key file 30 contains a user ID number 31, a password 32, an issuance number 33, and a private key 34. The public key file 40 contains a user ID number 41, an issuance number 42, and a public key 43. The correspondence between a private key and a public key is maintained by the issuance numbers 33 and 42.

The private key file 30 stored on an IC card or a floppy disk is pre-distributed to an order-sending clerk. Before starting the job, the order-sending clerk inserts the storage medium into the device, that is, the floppy disk into the floppy disk drive or the IC card into the IC card reader. In this embodiment, the private key stored on the floppy disk 29 is distributed.

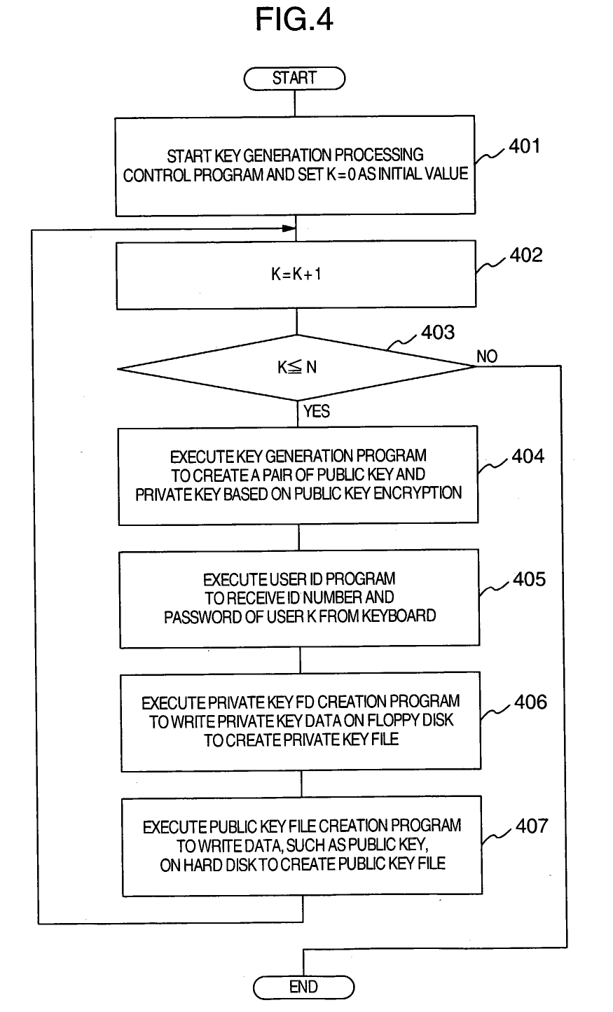

FIG. 4 is a flowchart showing how to create a private key on the processor 1. When there are multiple order-sending clerks, multiple private key files may be created for multiple order-sending clerks, one for each, or one private key file may be shared. In the description below, N private keys are created for N order-sending clerks.

In step 401, the whole control program 160 starts the key generation processing control program 165 in response to a key creation instruction from the operator and sets the program counter K in the work area 166 to 0. In step 402, 1 is added to K to count the issuance number. In step 403, the value of K is compared with the value of N. If K≦N, control is passed to step 404 and the following steps; otherwise, processing is terminated.

In step 404, the key generation program 1651 is used to store a pair of a private key and a public key, based on the public key encryption, into the memory in the work area 166.

In step 405, the user ID registration program 1652 is executed to store the user ID numbers 31 and 41 and the password 32 of a user, entered via the keyboard 12 by the key creation clerk, into the memory of the work area 166. It is desirable that the key creation clerk set a default value for the password 32 to allow the user to change the password when he or she uses it.

In step 406, the private key FD creation program 1653 is executed. This program uses the data stored in the memory to write the ID number 31, default password 32, issuance number 33, and public-key-encryption based private key 34 of one user into the private key file 30 on the floppy disk 29 newly inserted by the key creation clerk for storing the private key.

In step 407, the public key file creation program 1654 is executed to write data, which is stored in the memory, into the user ID number 41, issuance number 42, and public key 43, shown in FIG. 3, of the user K in the public key file 40 on the hard disk 24 via the network.

By repeating steps 402-407 described above for all users (N), the contents such as those shown in FIG. 3 are stored in the private key file 30 and the public key file 40 on the floppy disk and the hard disk. A floppy disk, on which the private key file 30 for encryption is stored, is given in advance to the order-sending clerk before starting the job. The hard disk 24 of the processor 2, on which the order-receiving job is executed, contains N public keys.

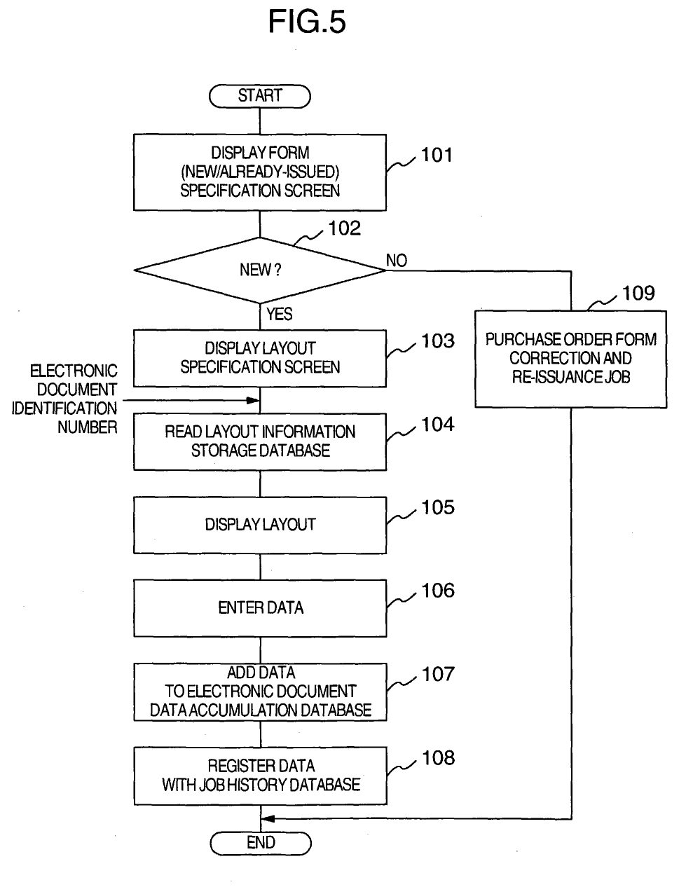

With reference to the flowchart in FIG. 5, the processing of the order data creation program 162 will be described. The order data creation program 162 is composed of the following two types of processing: (1) Issue a new purchase order form (purchase order form issuance) and (2) Correct an already-issued purchase order form and re-issue a purchase order form (purchase order form correction and re-issuance). In response to an order-sending start instruction from the order-sending clerk, the whole control program 160 starts the order-sending job control program 161, which, in turn, starts the order data creation program 162.

In step 101, the order data creation program 162 displays the screen on the display 11 to allow the order-sending clerk to select one of (1) purchase order form issuance job and (2) purchase order form correction and re-issuance job and waits for the order-sending clerk to enter. The order-sending clerk specifies one of (1) purchase order form issuance job and (2) purchase order form correction and re-issuance job via the keyboard 12 or the mouse 13.

In step 102, a check is made if the specified job is the purchase order form issuance job. If it is found that the job is (1) purchase order form issuance job, control is passed to step 103. If it is found that the job is (2) purchase order form correction and re-issuance job, control is passed to step 109. The following describes the contents of processing executed for (1) purchase order form issuance job. Step 109 ((2) purchase order form correction and re-issuance job) will be described later.

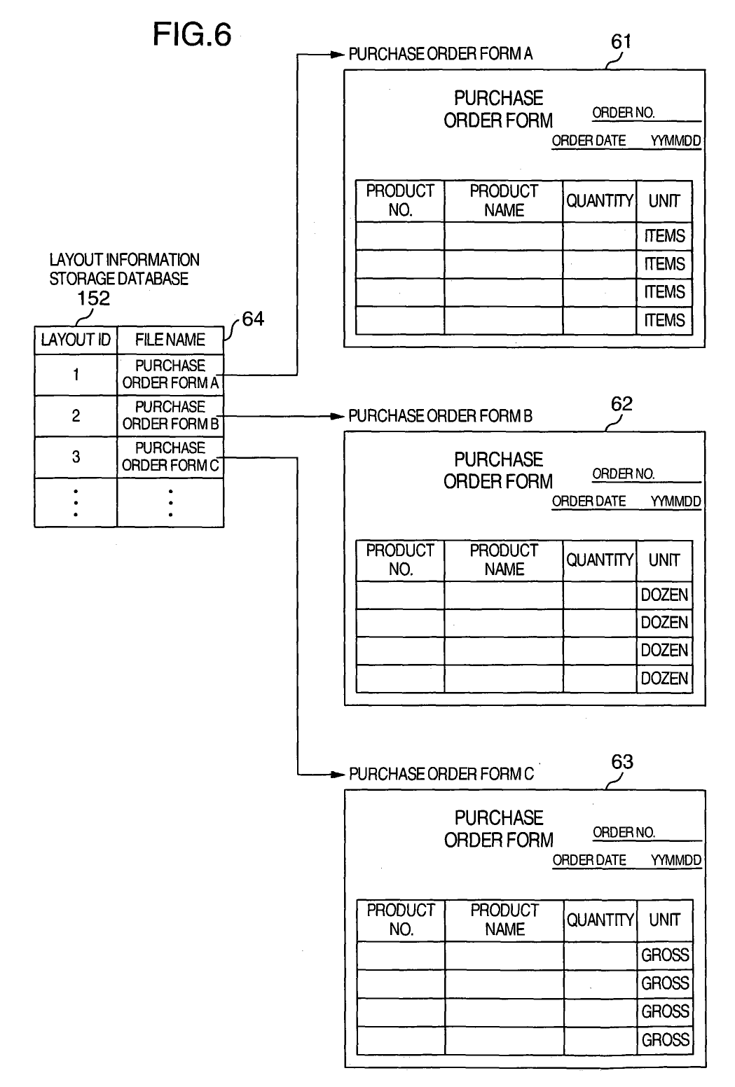

The layout information storage database 152 stores a plurality of electronic document layout information such as those shown in FIG. 6. In step 103, reference is made to the layout information storage database 152, the format information on electronic documents is displayed on the display 11, and the screen is displayed to prompt the order-sending clerk to specify an electronic document to be used via the keyboard 12 or the mouse 13. Assume that, in the description below, a purchase order form A 61 in FIG. 6 is selected. The selected layout ID is used as the electronic document identification number. In step 104, this ID is used to reference the layout information storage database 152, and the corresponding layout information is read into the work area 166. In step 105, an electronic document is displayed on the display 11 based on the layout information that has been read. Table 64 in FIG. 6 shows the contents of the layout information storage database 152. In Table 64, the layout ID of purchase order form A is “1”.

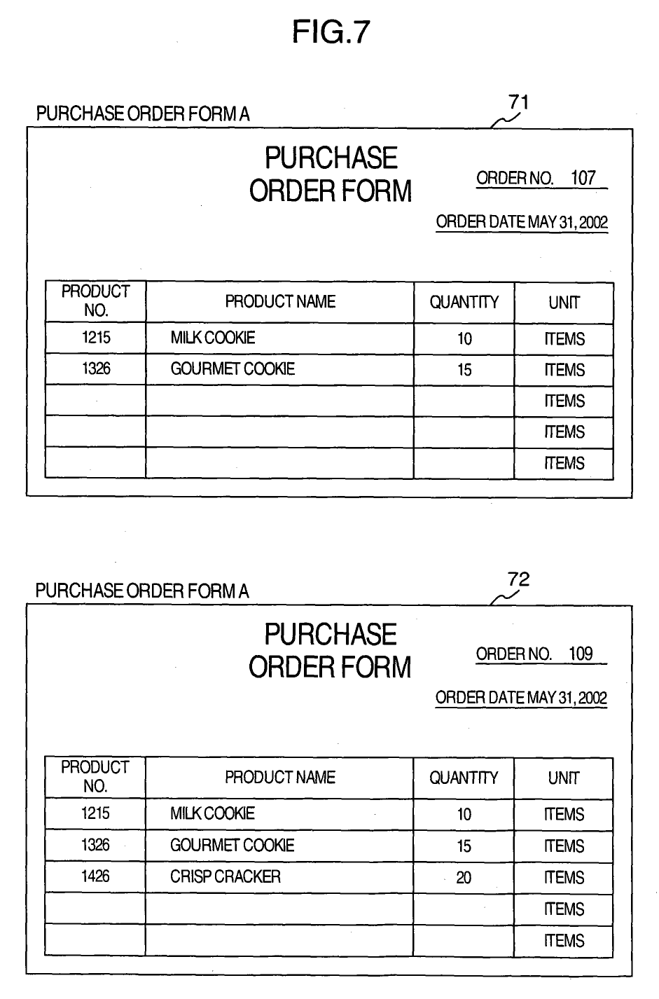

In step 106, data necessary for order sending is entered based on the information on the screen. In this example, product numbers and the number of required items are entered. The date and the order number may be assigned automatically or may be entered manually by the clerk. In this example, they are assigned automatically. The order data creation program 162 checks the consistency of entered data, searches the product database 151 for product names based on product numbers, and displays the result. An instance of purchase order form 71 in FIG. 7 shows the electronic document that has been filled out.

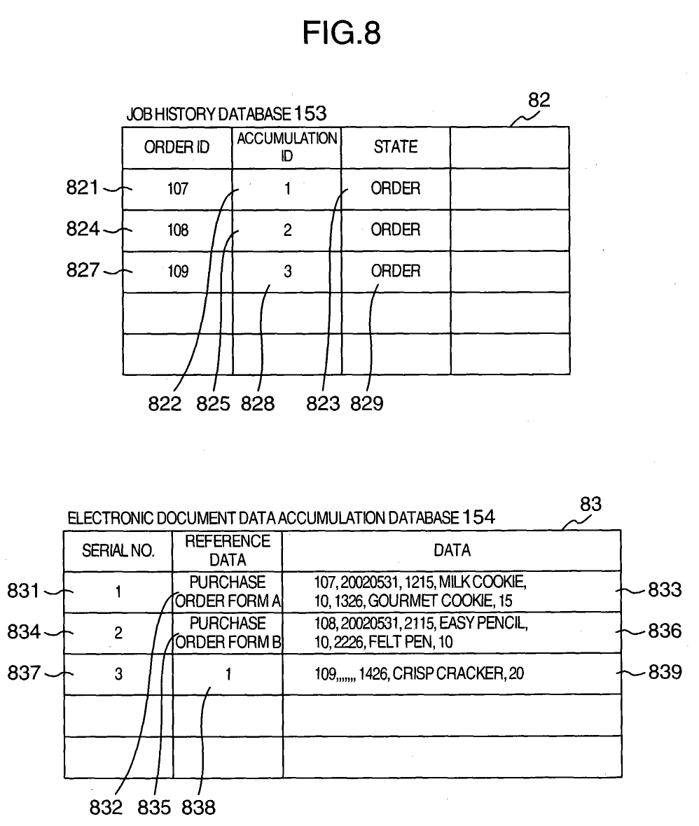

When the order-sending clerk enters an instruction indicating that data entry is finished, the data obtained by the order data creation program 162 and the referenced electronic document names are registered with the electronic document data accumulation database 154 as reference data in step 107. The serial number is allocated and registered. Table 83 in FIG. 8 shows the contents of the electronic document data accumulation database 154. “1” is stored in the serial number 831, “Purchase order form A” is stored in the reference data 832, and “107, 20020531, 1215, Milk Cookie, 10, 1326, Gourmet Cookie, 15” is stored in the data 833, respectively.

In step 108, data is registered with the job history database 153. Table 82 in FIG. 8 shows the contents of the job history database 153. In the job history database 153, the order number “107” of the purchase order form is stored in the order ID 821, the serial number (data 831 in FIG. 8) allocated in step 107 is stored in the accumulation ID 822, and “Order” is stored in the state 823 of the electronic document, respectively.

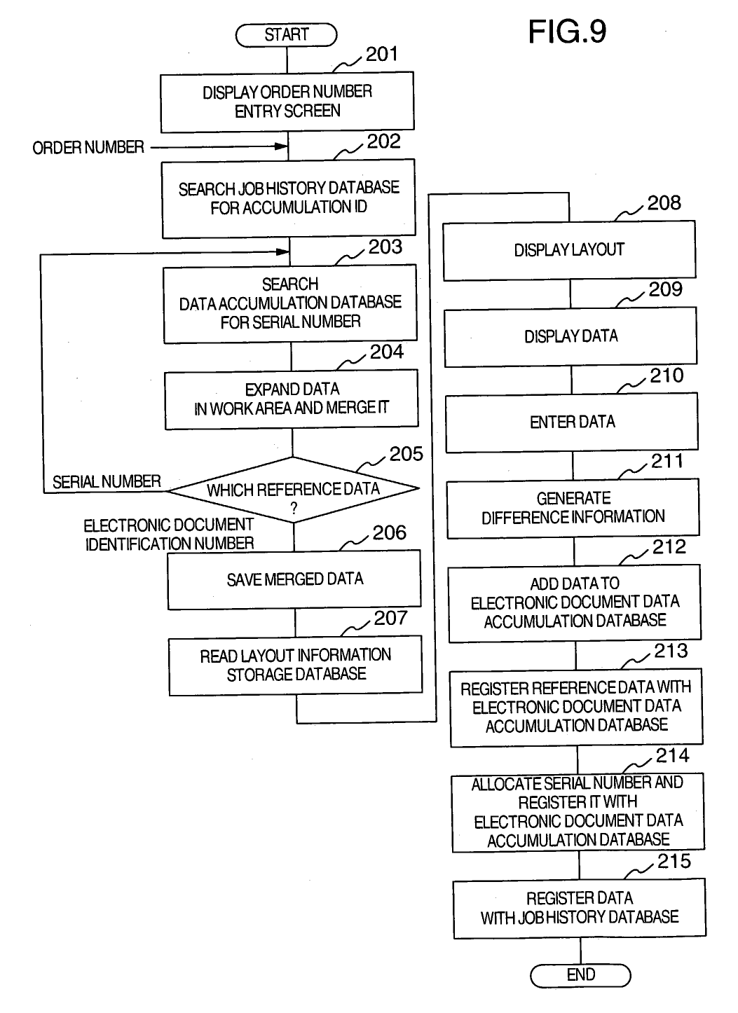

Next, with reference to the flowchart in FIG. 9, “(2) Purchase order form correction and re-issuance” in step 109 in FIG. 5 will be described. Assume that a purchase order form correction and re-issuance request is issued to the electronic document of the purchase order form 71 in FIG. 7.

In step 201, the order number entry screen is displayed on the display 11 to prompt the order-sending clerk to enter the number of a purchase order form via the keyboard 12 or the mouse 13. In this example, “107” is specified as the “Order ID”.

In step 202, reference is made to the job history database 153 to search for the corresponding purchase order form number, and the corresponding accumulation ID is obtained. In this example, “1” is obtained as the “Accumulation ID”.

In step 203, the electronic document data accumulation database 154 is searched for the serial number that matches the accumulation ID obtained in step 202 and, in step 204, the corresponding data is expanded (stored) in the memory in the work area 166. In this example, data “107, 20020531, 1215, Milk Cookie, 10, 1326, Gourmet Cookie, 15” is expanded in the memory.

If it is found in step 205 that value of the reference data of the record referenced in step 203 is a serial number, control is passed back to step 203 and the search for corresponding serial number is repeated. If it is found that the value of the reference data is an electronic document identification number, control is passed to step 206. In this case, control is passed to step 206 because the value is “Purchase order form A” and then data in the work area 166 is saved.

In step 207, reference is made to the layout information storage database 152, the layout information on the electronic document identification number obtained in step 205 is read, and the layout is displayed in step 208.

In step 209, the data expanded in the work area 166 is displayed on the display 11.

In step 210, data, that is, the product number and the number of required items are entered. The date and the order number are automatically allocated, the consistency of the entered data is checked, the product database 151 is searched for the product name based on the product number, and the result is displayed. An instance of purchase order form 72 in FIG. 7 is the electronic document that has been filled out.

In step 211, the difference information is generated. The difference from the data on the screen is extracted by referencing the data saved in step 206. Here, data “109 , , , 1426, Crisp Cracker, 20” is obtained. The difference information is added to the electronic document data accumulation database 154 as data (data 839 in FIG. 8) in step 212, the reference data referenced at the start of electronic document processing is stored in step 213 (data 838 in FIG. 8), and the serial number is allocated in step 214 (data 837 in FIG. 8) and is stored in the electronic document data accumulation database 154.

In step 215, the following are stored in the job history database 153. That is, the order ID is stored in the order ID column (data 827 in FIG. 8), the serial number allocated in step 214 is stored in the accumulation ID column (data 828 in FIG. 8), and “Order” is stored as the electronic document state column.

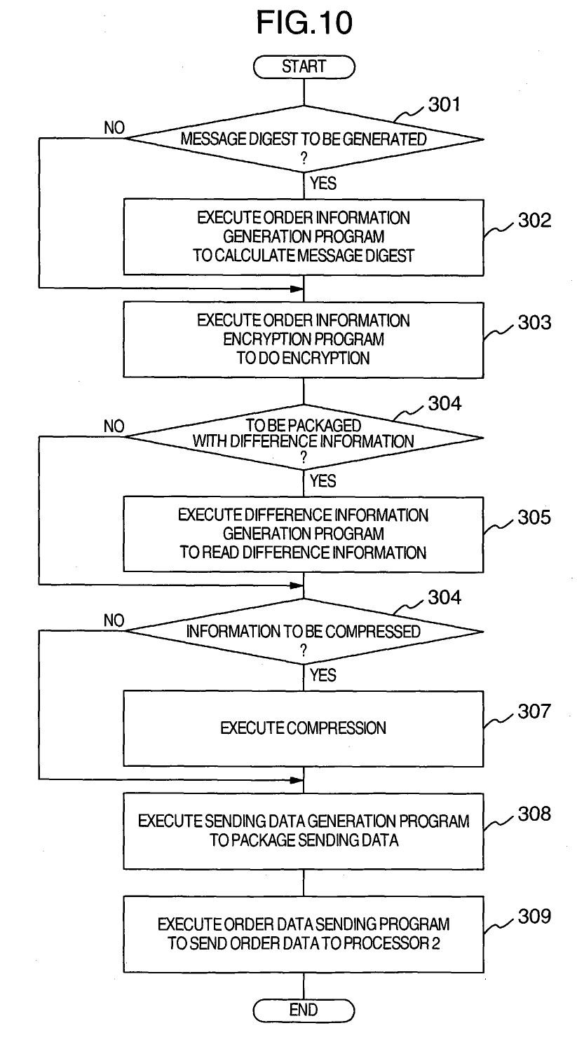

After the order data creation program 162 is finished, the sending data generation control program 163 is executed. FIG. 10 describes the flowchart.

When the message digest of order information is generated to reduce data to be encrypted and to reduce the processing time (step 301), the sending data generation control program 163 starts the order information generation program 1631 (step 302). The purpose is to calculate the message digest of the order information in the work area 166. This information is composed of the layout information on the purchase order form specified in step 103, the entered data, and the product name, date, and order number generated by the order data creation program 162. Encrypting the message digest that is the summary of data can reduce the processing time.

In step 303, the order information encryption program 1632 is started to encrypt the order information or the message digest of the order information calculated in step 301 using the private key file 30 owned by the order-sending clerk. In this case, it is also possible to provide, for example, an encryption confirmation button on the screen. When this button is provided, the program can wait for the order-sending clerk to press the button. Upon confirming that the order-sending clerk explicitly wants to start encryption, the program reads a private key from the floppy disk and starts encryption.

When difference information, which is a part of the order information, is packaged with the encrypted order information (step 304), the difference information generation program 1633 is started in step 305, the reference data 838 and the data 839 stored in the electronic document data accumulation database 154 are read, and the difference information is generated.

When the order information or the difference information is compressed (step 306), compression processing is executed in step 307. In step 308, the sending data generation program 1635 packages the order information or difference information and the encrypted data obtained in step 303 using software that converts information into serialized bit strings. In step 309, the order data sending program 164 sends the binary data strings, packaged in step 308, to the processor 2.

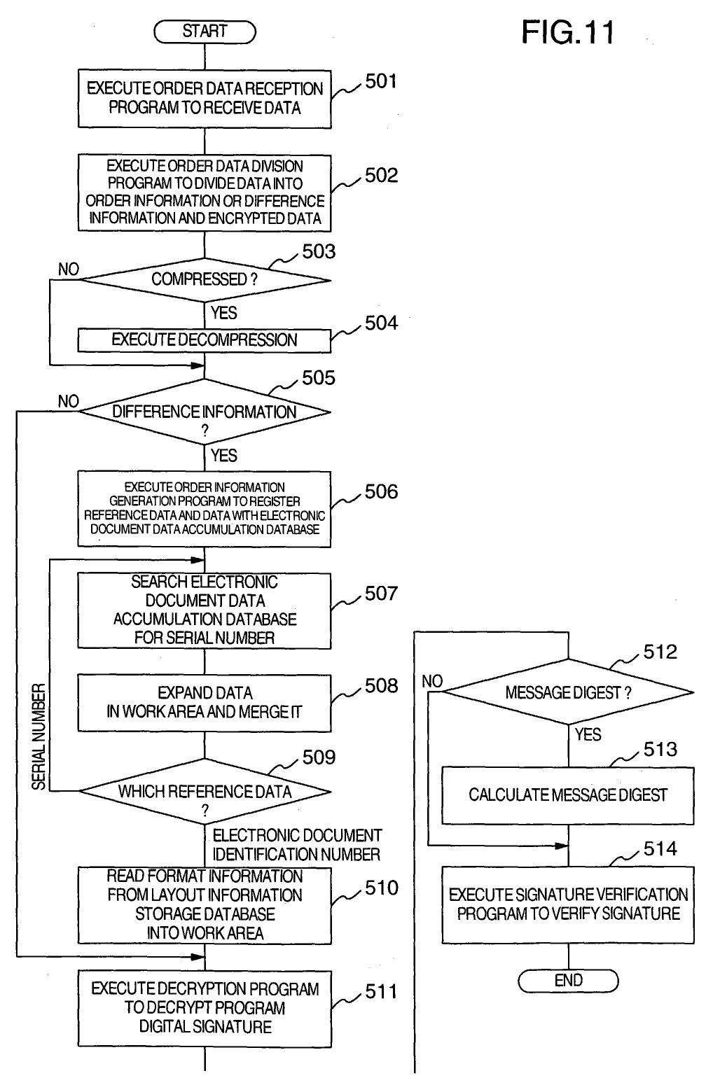

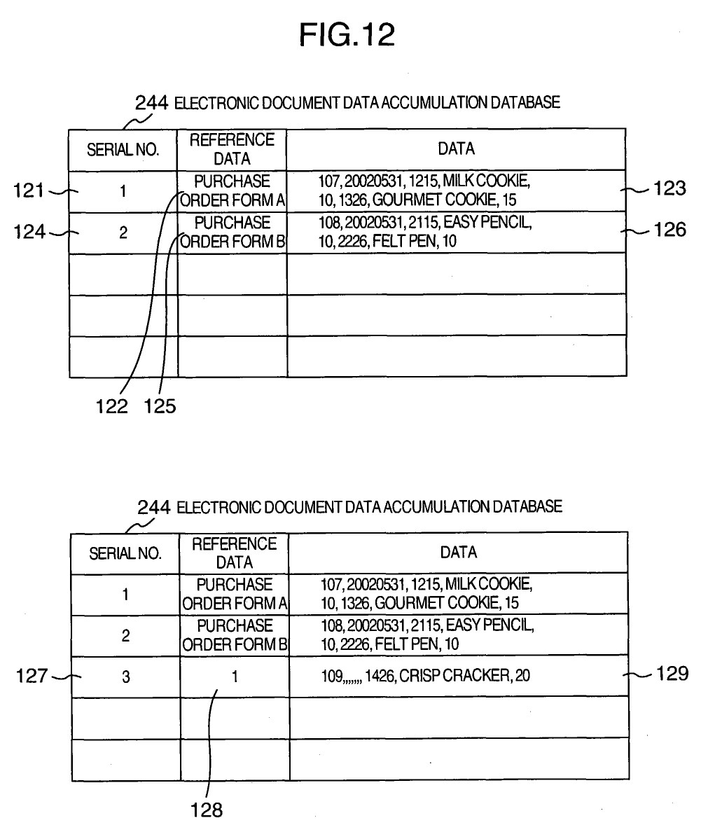

Next, the processing of the processor 2 will be described. The layout information storage database 242 has the same contents as those of the layout information storage database 152 of the processor 1, and the electronic document data accumulation database 244 (FIG. 12) has the same format as that of the electronic document data accumulation database 154. With reference to the flowchart in FIG. 11, the reception processing of the purchase order form 72 shown in FIG. 7 will be described.

On the processor 2, the order data reception program 252 is always active and is always ready for receiving data.

When data is received from the processor 1 in step 501, the order-receiving job control program 251 starts the order data analysis control program 253 in step 502 and, in addition, the order data analysis control program 253 starts the order data division program 2531. In this step, the data received from the processor 1 is divided into the order information or difference information and the encrypted data.

If it is found in step 503 that the order information or the difference information is compressed, the decompression program 2534 is executed to decompress the information (step 504).

Next, the order information generation program 2532 is executed to generate the order information. If the received data is difference information (step 505), the reference data and the data are extracted in step 506 from the difference information obtained in step 502 or from the difference data decompressed in step 504 and then the extracted data is stored in the reference data 128 or the data 129 of the electronic document data accumulation database 244. The value of the reference data 128 is “1”, and the value of the data 129 is “109 , , , 1426, Crisp Cracker, 20”. In addition, the value of the data 129 is written in the work area 255.

Because the value of the reference data 128 is “1”, the search is made for a record containing the serial number “1” in step 507. In step 508, the value of data 123 corresponding to the serial number “1” is referenced and is merged into the work area 255. In this case, the merged result is “109, 20020531, 1215, Milk Cookie, 10, 1326, Gourmet Cookie, 15, 1426, Crisp Cracker, 20”.

In step 509, control is passed back to step 507 if reference data 122 is a serial number or to step 510 to read the corresponding layout information storage database 242 if the reference data 122 is an electronic document identification number. Because the reference data 122 is “Purchase order form A”, the format information on “Purchase order form A” is read into the work area 255 be referring to the layout information storage database 242 and then the generation of the order information is finished. In this case, the order information is the format information on purchase order form A and the value generated in step 508 “109, 20020531, 1215, Milk Cookie, 10, 1326, Gourmet Cookie, 15, 1426, Crisp Cracker, 20”. In step 511, the encrypted data is decrypted by referring to the public key file 40.

If the decrypted data is the message digest (step 512), the message digest of the order information is calculated in step 513. In step 514, the message digest obtained in step 513 is compared with the message digest decrypted in step 511, or the order information is compared with the order information decrypted in step 511, to verify whether substitution was done.

A match between the two units of data indicates that the order information created on the processor 1 by the order-sending clerk with the use of the order data creation program 162 matches the order information generated on the processor 2 with the use of the order information generation program 2532. Therefore, it is determined that the order information was created surely by the order-receiving clerk. A mismatch indicates that the order information was not created by the order-sending clerk.

As described above, a substitution, even if made to the original, may be detected easily by encrypting a purchase order form. This ensures safe electronic commerce.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An electronic commerce method for sending and receiving an electronic document between two or more information processors connected via a network, said method comprising the steps of:
encrypting electronic document data, processing electronic document data, packaging the encrypted electronic document data and the processed electronic document data, and sending the package by an electronic-document sending processor; and
un-packaging received data into processed electronic document data and encrypted electronic document data, restoring the processed electronic document data, decrypting the encrypted electronic document data, and checking whether the restored electronic document data matches the decrypted electronic document data by an electronic-document receiving processor.

2. The electronic commerce method according to claim 1,
wherein template data common to at least two processors is provided,
wherein, when the electronic document data is processed, said electronic-document sending processor extracts difference information between the electronic document data and the template data and
wherein, when the processed electronic document data is restored, said electronic-document receiving processor combines the template data and the difference information.

3. The electronic commerce method according to claim 2,
wherein, when the electronic document data is processed, the difference information is compressed and
wherein, when the processed electronic document data is restored, the compressed difference information is decompressed.

4. The electronic commerce method according to claim 1,
wherein, when the electronic document data is processed, said electronic-document sending processor compresses the electronic document data and
wherein, when the processed electronic document data is restored, said electronic-document receiving processor decompresses the compressed electronic document data.

5. The electronic commerce method according to claim 1,
wherein, when the electronic document data is encrypted, a message digest of the electronic document data is calculated and the message digest of the electronic document data is encrypted and
wherein, when whether the restored electronic document data matches the decrypted electronic document data is checked, a message digest of the restored electronic document data is calculated and whether the calculated message digest matches the decrypted message digest is checked.

6. The electronic commerce method according to claim 5,
wherein template data common to at least two processors is provided, wherein, when the electronic document data is processed, said electronic-document sending processor extracts difference information between the electronic document data and the template data and
wherein, when the processed electronic document data is restored, said electronic-document receiving processor combines the template data and the difference information.

7. The electronic commerce method according to claim 6,
wherein, when the electronic document data is processed, the difference information is compressed and
wherein, when the processed electronic document data is restored, the compressed difference information is decompressed.

8. The electronic commerce method according to claim 5,
wherein, when the electronic document data is processed, said electronic-document sending processor compresses the electronic document data and
wherein, when the processed electronic document data is restored, said electronic-document receiving processor decompresses the compressed electronic document data.

9. An electronic commerce system for sending and receiving an electronic document between two or more information processors connected via a network,
wherein an electronic-document sending processor comprises means for encrypting electronic document data; means for processing electronic document data; means for packaging the encrypted electronic document data and the processed electronic document data; and means for sending the package; and
wherein an electronic-document receiving processor comprises means for un-packaging received data into processed electronic document data and encrypted electronic document data; means for restoring the processed electronic document data; means for decrypting the encrypted electronic document data; and means for checking whether the restored electronic document data matches the decrypted electronic document data.

10. The electronic commerce system according to claim 9,
wherein template data common to at least two processors is provided,
wherein said electronic-document sending processor further comprises means for extracting difference information between the electronic document data and the template data for use when the electronic document data is processed, and
wherein said electronic-document receiving processor further comprises means for combining the template data and the difference information for use when the processed electronic document data is restored.
